(19) United States
(12) Patent Application Publication
(10) Pub. No.: US 2005/0257613 A1
(43) Pub. Date: Nov. 24, 2005

(54) Fluid level gauge comprising synthetic sapphire shielding and/or viewing lense

(76) Inventors: John Spencer, Halifax (CA); David Kalix, Fall River (CA)

Correspondence Address: ARLEN L. OLSEN;SCHMEISER, OLSEN & WATTS, 3 LEAR JET LANE, SUITE 201, LATHAM, NY, 12110, US

(21) Appl. No.: 11/019,022

(22) Filed: Dec. 21, 2004

(30) Foreign Application Priority Data
May 20, 2004 (CA) 2,468,068

(51) Int. Cl. G01F 23/02

(52) U.S. Cl. 73/323

(57) ABSTRACT

A fluid level gauge for determining the water level within a boiler steam drum or similar device, wherein optical grade synthetic sapphire is utilized as a replacement for the conventional mica reinforced glass. The fluid level gauge is typically used for measuring a fluid level in a tank interior, and comprises a gauge body defining a cavity and first and second end openings respectively formed at or near first and second ends of the gauge body. The end openings allow fluid communication between the gauge body exterior and the cavity. Viewing means comprising one or more synthetic sapphire shield or synthetic sapphire lense are provided for observation of the cavity interior. The synthetic sapphire shield(s) or lense(s) are sealingly engaged in fluid-tight manner with the gauge body, and prevent the discharge of steam, water, or other fluids from the tank into the environment when the fluid level gauge is connected to the tank.

### FIELD OF THE INVENTION

The present invention relates, generally, to an improved fluid level gauge of the sort typically used to detect fluid levels in steam drums. More specifically, the invention relates to a fluid level gauge which utilizes synthetic sapphire shielding and/or viewing windows.

### BACKGROUND OF THE INVENTION

The design and use of level gauges to determine the water level in high pressure boiler steam drums is well taught and documented in the art. For instance, U.S. Pat. No. 2,510,729 describes a fluid level gauge in which a vertical column containing both water and steam includes a multitude of bores passing horizontally through the column and allowing for visual inspection of the contents of the column present at the corresponding level. An operator is able to inspect and determine the level at which the contents of the column shift from water to steam.

In U.S. Pat. Nos. 2,024,815 and 2,115,889, indicators that utilize the reflective and refractive properties of water, steam and light are disclosed. In each case, the operator inspects the individual gauges within a plurality of gauges and is able to determine the water/steam level by observing a colour change associated with the level corresponding to the change from water to steam. The device of U.S. Pat. No. 2,115,889 provides an additional means to visually inspect the gauge at a greater distance, more specifically, at a position located far below the gauge. The light is provided in each of these devices via an incandescent light source.

Variations of these types of level gauges are manufactured by Clark-Reliance Corporation and Cesare Bonetti S.p.A. For instance, the website of Cesare Bonetti S.p.A. (www.cesare-bonetti.it/Products/Level/bicol01.htm) shows an instrument consisting of a stainless steel body machined to have a longitudinal chamber and front holes uniformly distributed on opposing faces. On each hole a high temperature resistant aluminium silicate transparent cylindrical glass window is tightly pressed between a metallic cover and the body by means of bolts and nuts. A mica shield is also included to protect the glass from the boiler water. The chamber is connected to the vessel with cross fittings and flanged, threaded or welded ends. Also shown are flat glass level gauges of similar design, which are equipped with long glass windows instead of cylindrical windows.

The aforementioned prior art level gauges typically incorporate mica shielding to protect the viewing glass from the erosive effects of high-pressure steam. Without this mica shield, even the very best glass will fail in a very short time when placed under high-pressure steam service.

Mica is a naturally occurring mineral that is mined and then processed into the required shapes for visual level gauge applications. However, because it is a natural material, the quality and color of this product can vary significantly. Additionally, the material is available in very limited thicknesses. Moreover, mica will degrade over time, necessitating significant level gauge maintenance.

Synthetic sapphire crystals have the basic chemical formula Al₂O₃, (Aluminum oxide), and have chemical and physical properties that are far superior to mica. For instance, the sapphire material is perfectly clear, unlike mica which is amber colored. This makes it much easier to view the gauge water level. Additionally, the sapphire material is harder and more durable than glass or mica reinforced glass, and has an extremely high melting temperature.

Synthetic sapphire is known for it's durability under extreme conditions, and has thus been used in optical instruments and sensors employed under high temperature and pressure. For instance, the use of sapphire as part of a complex analytical measurement system designed to collect material property data on subsurface materials under extreme temperature and pressure conditions has been disclosed in Canadian Patent No. 1,189,202. In this measurement system, at least one window of the measurement cell is constructed of sapphire.

Furthermore, a device for use in gas turbine testing has been disclosed in U.S. Pat. No. 5,608,515, wherein a sapphire window is incorporated to protect an analytical sensor from the harsh high temperature environment during flame combustion analysis. Similarly, U.S. Pat. No. 5,604,532 discloses a probe designed to inspect vessels while they are pressurized, wherein the probe comprises a sapphire window. The probe is inserted through a ball valve into the tank to be inspected, and a closed circuit camera transmits the image from the moveable probe while the operator inspects the tank.

Canadian Patent No. 2,205,746 discloses an apparatus which employs a single optical probe to discriminate between the three phases of a fluid mixture, ie. gas, water and liquid oil. The detector operates on the principle that these three phases of the fluid mixture have different refractive properties. The detector block is made of sapphire, ruby or diamond in order to account for environmental requirements.

Sapphire has also been used in further analytical probe applications, as disclosed in U.S. Pat. No. 6,341,890 and U.S. Patent Application Publication No. 2003/0142304, as well as in sensor housings and windows in missiles, as discussed in Canadian Patent No. 2,267,562.

### SUMMARY OF THE INVENTION

While synthetic sapphire has been used in the above described applications, it's use in visual fluid level gauges is entirely novel. Thus, in order to overcome the disadvantages involved with using mica shielding in high pressure fluid level gauges, the present invention provides a fluid level gauge for use in high-pressure service wherein mica shielding is replaced with a synthetic sapphire crystal material.

Accordingly, an object of the present invention is to provide a fluid level gauge which incorporates a synthetic sapphire shield and/or viewing lense.

According to an aspect of the present invention, there is provided a fluid level gauge for measuring a fluid level in a tank interior, the fluid level gauge comprising a gauge body defining a cavity and having first and second end openings respectively formed at or near first and second ends of the gauge body, the end openings allowing fluid communication between the gauge body exterior and the cavity; and viewing means disposed in a side wall of the gauge body for observation of the cavity interior, and comprising one or more synthetic sapphire shield and/or lense; wherein the one or more synthetic sapphire shield and/or lense is sealingly engaged in fluid-tight manner with the side wall of the gauge body and prevents the discharge of steam, water, or other fluids from the tank into the environment when the fluid level gauge is connected to the tank.

The fluid level gauge is typically a high pressure gauge for measuring fluid levels in a steam drum, ie. for measuring water and steam levels. However, fluid level gauges incorporating synthetic sapphire shielding, or lenses, may also be designed for measuring levels of other clear fluids, including very thin hydrocarbons such as gasoline and propane.

Generally, the fluid level gauge will be of a ported or flat glass style. In either style, the viewing means may comprise a glass lense. In order to fit properly with the various components typically used in such fluid level gauges, the glass lense will advantageously have a thickness ranging from about 0.4 to about 0.6 inches, and will preferably be about 0.5 inches in thickness. In order to shield the glass lense from the corrosive effects of steam, water, or other fluids which enter the measuring gauge cavity, the gauge will also comprise a synthetic sapphire shielding layer. The thickness of this shielding layer may vary, since it's main function is, simply, to prevent the aforementioned fluids from contacting the glass lense. However, it is preferred for the synthetic sapphire shield to correspond with the thickness of typical mica shielding, which usually ranges from approximately 0.01 to 0.015 inches in thickness per mica shield, so that the combination of the glass lense and synthetic sapphire shielding will be compatible with parts normally used to manufacture fluid level gauges.

In an alternate arrangement, the glass lense and shielding layer may be replaced with one or more single synthetic sapphire lenses. In such an arrangement, the synthetic sapphire lense is preferred to have a thickness roughly equivalent to the stack-up height of traditional glass lenses and mica shielding, in order to ensure compatibility with replacement parts and materials commonly used in the manufacture of fluid level gauges. For instance, the clamping force exerted by certain components of the device, such as belleville spring washers, is controlled by the stack-up height. Accordingly, the synthetic sapphire lense may vary in thickness, but will typically be about 0.41 to about 0.63 inches in thickness, and preferably about 0.51 inches in thickness, in order to facilitate the use of commercially available parts in the manufacture of the present fluid level gauge. If multiple lenses are used, the total stack-up height will typically be in the same thickness range.

In the ported style fluid level measuring gauge, the viewing means will preferably comprise a plurality of viewing ports affixed to opposing sidewalls of the gauge body in a columnar orientation. Typically, the viewing ports are vertically and horizontally aligned with the ports on the opposing gauge sidewall in order to permit light to pass through the gauge and thus enable observation of the fluid level.

Generally, the viewing ports will comprise a viewing port assembly which includes a port cover. The port cover advantageously defines a viewing aperture and a lense support rim for retaining the sapphire lense within the viewing aperture. The port cover may be threaded, or it may have two or more bolt holes therethrough to facilitate attachment to the gauge body. It is also preferred for the assembly to comprise a sealing gasket, typically a graphoil gasket in order to account for high temperatures, which seals the synthetic sapphire shield/lense against the gauge body. Alternate means of sealing the sapphire against the level gauge body include, but are not limited to, resilient seals, graphoil packing, solid and hollow core metal seals and brazing. A gasket retainer may also be included to hold the sealing gasket centered, and to hold the synthetic sapphire shield on the glass during assembly of the viewing port. The gasket retainer is normally made of stainless steel in order to withstand the high temperatures used in the boiler applications, ie. up to 700 degrees F. One or more washers, typically steel, may be included to provide a flat surface for the synthetic sapphire or glass lense against the lense support rim, as well as a cushion gasket to prevent high stress points from occurring on the glass/sapphire lense against the steel washer. A retaining spring is advantageously included to hold the lense centered in the aperture during assembly. The viewing ports are generally bolted to the body of the fluid level measuring gauge, preferably by four bolts which are passed through the bolt holes of the port cover and threaded into bolt holes formed in the gauge body. The ports can also be retained with a threaded cover.

The ported style level gauge of the present invention will typically be of transparent or “bi-colour” format. As opposed to the transparent format in which the lenses are installed parallel to the gauge body, the lenses in the bi-colour gauge are installed at an angle with respect to the gauge body. In such cases, the lenses are mounted in vertical and horizontal alignment with the lenses of opposing ports, but are not parallel therewith. As a result of this angled orientation, coloured light may be projected through the gauge in order to obtain the red/green effect typical to such bi-colour gauges.

Flat glass style level gauges generally include transparent and reflex categories. However, mica shielding is not commonly used in the reflex format. Accordingly, the reflex style gauge as defined herein will advantageously incorporate a solid sapphire lense without mica shielding.

In the flat glass format of the present fluid level gauge, the viewing means commonly comprises one or more elongated viewing window affixed to sidewalls of the gauge body, each viewing window having an elongated synthetic sapphire shield or lense. In the transparent style gauge, two elongated viewing windows will be included, attached on opposing sidewalls of the gauge body in order to permit light to pass through the gauge and thus enable observation of the fluid level. Alternately, the reflex configuration of the level gauge will include a single sapphire window which is grooved on one side, thus providing for the usual detection pattern wherein fluid appears black and steam appears white.

Generally, each viewing window will comprise a viewing window assembly, including a window cover. The window cover will preferably define an elongated viewing aperture and a lense support rim for retaining the sapphire shield or lense within the viewing aperture. It is also preferred for the window assembly to comprise a sealing gasket, typically a graphoil gasket in order to account for high temperatures, which seals the synthetic sapphire shield/lense against the gauge body. Alternate means of sealing the sapphire against the level gauge body include, but are not limited to, resilient seals, graphoil packing, solid and hollow core metal seals and brazing. The assembly further comprises a cushion gasket to prevent high stress points from occurring on the glass/sapphire lense against the lense support rim. A band, usually made of rubber, is also included to keep the glass or sapphire lense centered within the lense support rim during assembly and to separate the lense from machined surfaces. The viewing windows are usually fastened to the body of the fluid level measuring gauge with bolts, which are passed through bolt holes formed in the window covers and threaded onto nuts. Alternatively, the viewing windows can be retained by the use of a clamping mechanism. In such an embodiment, the window cover may form part of the clamping mechanism.

The fluid level measuring gauge may be adapted to engage with a pressure boiler steam drum. In such embodiments, the gauge will typically comprise first and second pipes sealingly engaged with the first and second end openings of the gauge body. These pipes may then be attached to the steam drum tank, preferably at different vertical levels thereof, in order to permit fluid communication between the interior of the tank and the measuring gauge cavity. The measuring gauge may also comprise flanges for attaching the first and second pipes to the tank.

Also provided by the present invention, as second and third aspects, is a method of manufacturing a fluid level measuring gauge as defined herein, and the use of synthetic sapphire as a shielding layer for a viewing lense or as a viewing lense in a fluid level gauge.

### BRIEF DESCRIPTION OF THE DRAWINGS

Embodiments of the present invention will be further described with reference to the accompanying drawings, in which:

FIG. 1a shows the construction of a conventional ported style level gauge which incorporates glass shielded by mica,

FIG. 1b illustrates, in exploded view, a single port section of the conventional ported style level gauge shown in FIG. 1b,

FIG. 2a depicts an embodiment of a ported style level gauge of the present invention, which incorporates glass shielded by sapphire,

FIG. 2b shows, in exploded view, a single port section of the embodiment of the ported style level gauge shown in FIG. 2a,

FIG. 3a illustrates a second embodiment of a ported style level gauge of the present invention, which incorporates a solid sapphire viewing lense,

FIG. 3b depicts, in exploded view, a single port section of the embodiment of the ported style level gauge shown in FIG. 3a,

FIG. 4 shows a conventional flat glass style level gauge incorporating a glass lense shielded by mica,

FIG. 5 illustrates an embodiment of a flat glass style level gauge of the present invention incorporating glass shielded by sapphire, and

FIG. 6 shows a second embodiment of a flat glass style level gauge of the present invention incorporating a solid sapphire viewing lense.

### DETAILED DESCRIPTION OF THE INVENTION

According to the present invention, synthetic sapphire crystals may be used either as a shielding layer for a viewing lense, or as a highly durable viewing lense in the viewing window of a fluid level gauge. In such applications, the sapphire shield/lense is sealed against the level gauge body and prevents the discharge of steam, water, or other fluids from the process into the environment. Since sapphire is a clear transparent material, the fluid level and other process equipment may be directly viewed in such a fluid level gauge, or alternatively, the fluid level may be determined with additional accessory equipment.

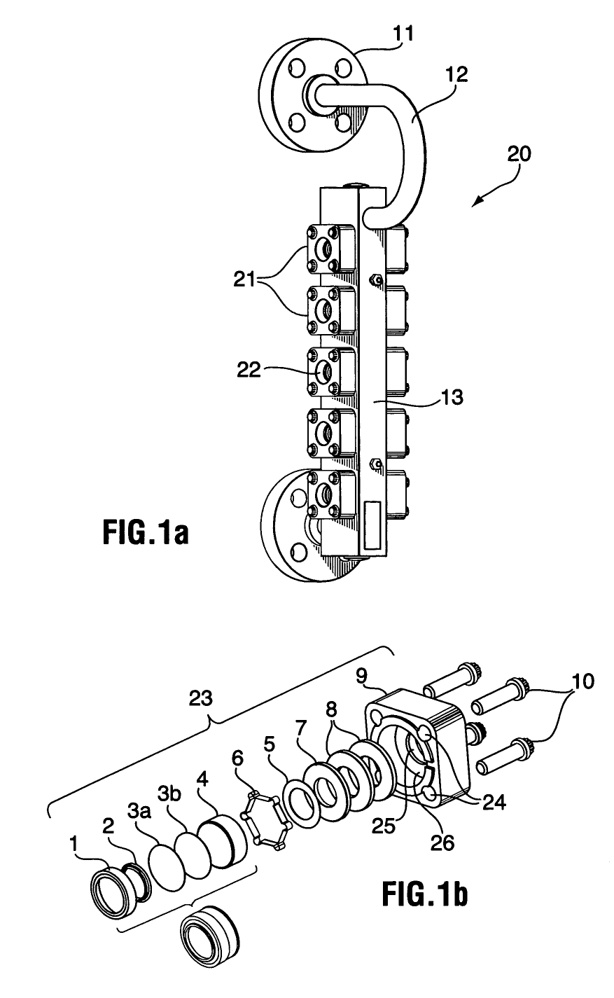

Although various applications may be envisioned, the use of synthetic sapphire is particularly advantageous in fluid level gauges used in pressure boiler steam drums and the like. Accordingly, without intending to limit the scope of the present invention, embodiments of the invention will be described below in further detail having regard to the ported and flat glass style high pressure visual level gauges shown in FIGS. 1a to 6.

FIG. 1a shows a conventional ported-style water level gauge 20. The water level gauge 20 is made up of a series of ports 21, arranged vertically along a column, or gauge body 13. Each port comprises an opening 22 covered by a glass lense 4, though which light may pass. When installed on a water boiler, e.g. using a mounting flange 11, water or steam or a combination of the two will pass from the boiler, through the pipe 12, and into the gauge body 13. An operator who wishes to inspect the gauge body 13 may peer through the series of ports 21, and determine the level of water within the gauge 20, and correspondingly, the boiler.

Port 21, as shown in exploded view in FIG. 1b, comprises a port assembly 23. The port assembly 23 comprises a port cover 9 having a viewing aperture 25 and four bolt holes 24 formed therein, and which defines a lense support rim 26. Cover bolts 10 pass through the bolt holes 24 in the port cover 9 and attach the port assembly 23 to the level gauge 20 via threaded bolt holes formed therein. The port assembly 23 also comprises a gasket retainer 1, which is generally used to hold mica shields 3a and 3b on glass lense 4 and hold sealing gasket 2 centered during assembly. Sealing gasket 2, which is typically graphoil, projects through the center of gasket retainer 1 and seals the first mica shield 3a against the gauge body 13. Alternately, seals may be formed by the gasket retainer 1 against the gauge body 13, and by the sealing gasket 2 against the gasket retainer 1 and the first mica shield 3a. The seal is particularly important to prevent release of process fluids such as steam and water. In order to provide the required shielding, mica shields 3a, 3b are arranged within the port assembly 23 so that they are positioned proximal to the interior of the level gauge 20 with respect to the glass lense 4. Also included within the port assembly 23 is a retaining spring 6, a cushion gasket 5, a flat washer 7 and two belleville washers 8, which are positioned distal to the interior of the level gauge 20 with respect to the glass lense 4. The flat washer 7 and two belleville washers 8 are usually stainless steel, and provide a flat supporting surface for the glass lense 4 against the lense support rim 26. The cushion gasket 5 is included between the glass lense 4 and the flat washer 7 in order to prevent high stress points from occurring on the glass lense 4 against the steel washer 7. The retaining spring 6 is included to hold the glass lense 4 centered in the aperture 25 during assembly of the port 21.

Usually, the glass lense 4 will be manufactured using tempered aluminosilicate glass, and is approximately 0.5 inches in thickness. Each mica shield 3a,3b is typically about 0.01 to 0.015 inches thick, in order to provide the desired shielding. Stainless steel is a common material used for gasket retainer 1 and retaining spring 6, since it can withstand the usual process temperatures, ie. up to 700 degrees Fahrenheit. The cushion gasket 5 may be a variety of materials, preferably non-asbestos, which can withstand temperatures up to 700 degrees Fahrenheit. Port cover 9, cover bolts 10, flange 11, pipe 12 and gauge body 13 are generally stainless steel, although a variety of other materials may be used depending upon the specific application for the gauge.

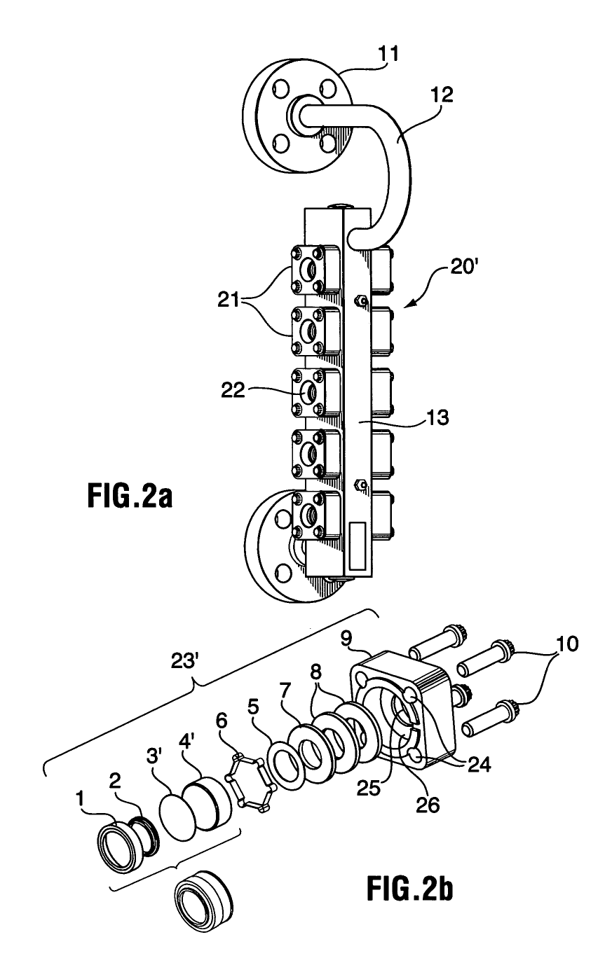

According to one embodiment of the present invention, which is shown in FIGS. 2a and 2b, the mica shields 3a, 3b are replaced with a synthetic sapphire shield 3′. The superior durability of the synthetic sapphire material as well as the ability to prepare the sapphire at a desired thickness prevents the need for two layers of shielding. In this embodiment, level gauge 20′ comprises glass lense 4′ having features similar to those described above, ie. it is manufactured using tempered aluminosilicate glass, and is approximately 0.5 inches in thickness. The synthetic sapphire shield 3′ ranges from approximately 0.02 to approximately 0.03 inches in thickness, in order to correspond with the combined thickness of mica shields 3a,3b, and is thus compatible with the parts normally used to manufacture fluid level gauge 20.

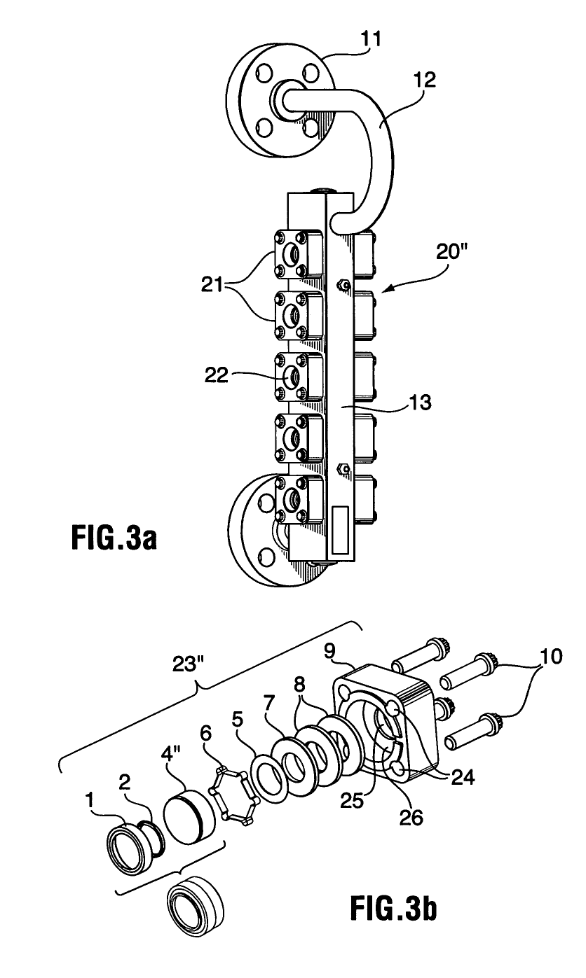

An alternate embodiment, shown in FIGS. 3a and 3b, dispenses with the combination of mica shields 3a,3b and glass lense 4 by using a single synthetic sapphire lense 4″. Although the thickness of the material may vary, the synthetic sapphire lense 4″ is preferred to have a thickness roughly equivalent to the stack-up height of glass lense 4 and mica shields 3a,3b, in order to ensure compatibility with parts and materials commonly used in the manufacture of fluid level gauge 20. Accordingly, synthetic sapphire lense 4″ used in level gauge 20″ will typically be about 0.42 to about 0.63 inches in thickness, and preferably about 0.52 inches in thickness, in order to facilitate the use of commonly available parts in the manufacture thereof. As an alternative, multiple synthetic sapphire lenses 4″ of various thickness can also be combined to attain the total thickness required.

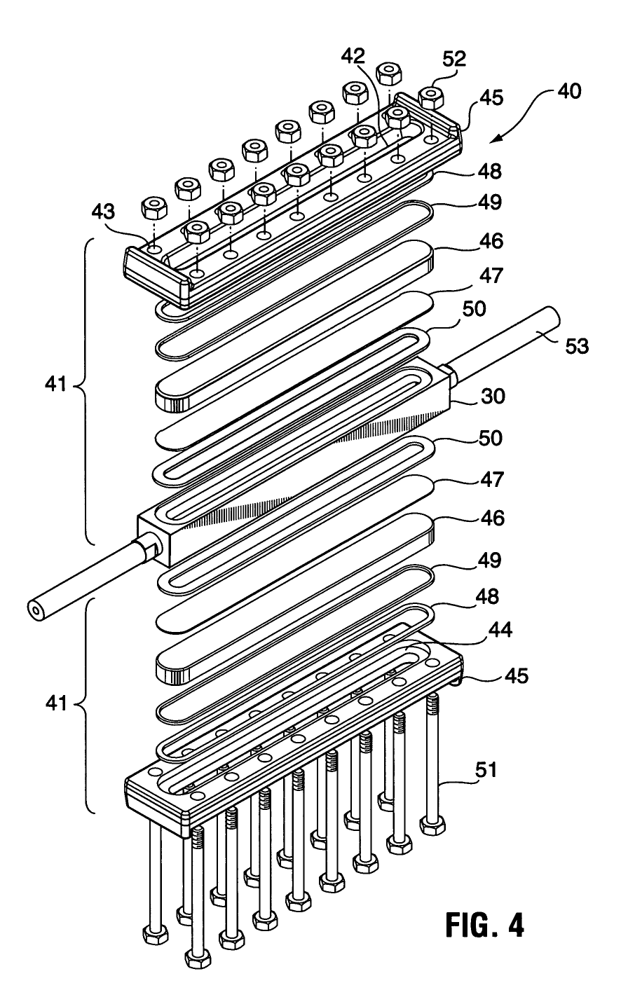

As mentioned above, synthetic sapphire may also be used in flat glass style fluid level pressure gauges. FIG. 4 shows, in exploded view, an example of a conventional transparent flat glass style fluid level gauge 40 having two elongated viewing windows affixed to opposing sides of the gauge body 30. Each viewing window comprises a viewing window assembly 41. The viewing window assembly 41 comprises a window cover 45 having an elongated viewing aperture 42 and a plurality of bolt holes 43 defined therein. The window cover 45 also has a lense support rim 44 formed therein. Also included in the viewing window assembly 41 is an elongated glass lense 46 and an elongated mica shield 47 for shielding of the glass lense 46 from the steam, water, or other fluids which enter the gauge body 30 when the fluid level gauge 40 is connected to a pressure boiler tank via pipe 53. The viewing window assembly 41 also comprises a cushion gasket 48 and a band 49 which are positioned between the glass lense 46 and the lense support rim 44 of the window cover 45. The cushion gasket 48 prevents high stress points from occurring on the glass lense 46 against the steel window cover 45. The band 49 is used to center the glass lense 46 in the gauge body 30 during assembly, and to prevent the glass lense 46 from contacting machined surfaces. A sealing gasket 50, which is typically graphoil, is included in the viewing window assembly 41 to form a seal between the mica shield 47 and the gauge body 30. Cover bolts 51 pass through the bolt holes 43 in the window covers 45 and are threaded onto cover nuts 52, thus securing the window assembly 41 to the gauge body 30. Alternate formats, not shown, may involve a clamping mechanism rather than bolting the window assembly 41 to the gauge body 30.

Usually, glass lense 46 is manufactured using tempered aluminosilicate or borosilicate glass, and is approximately 0.5 inches in thickness. Mica shield 47 is typically about 0.01 to 0.015 inches thick, in order to provide the desired shielding. The cushion gasket 48 may be a variety of materials, preferably non-asbestos, which can withstand temperatures up to 700 degrees Fahrenheit. Band 49 is generally made of an inexpensive material, such as rubber. Gauge body 30, window cover 45, cover bolts 51, cover nuts 52 and pipe 53 are generally carbon steel, although a variety of other materials may be used depending upon the specific application or the gauge.

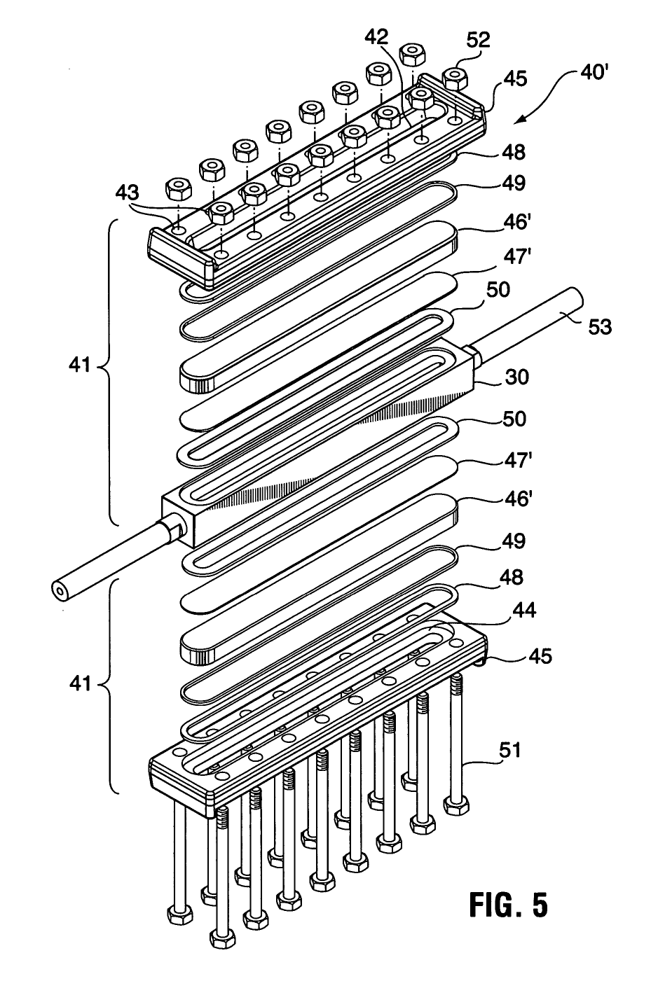

In the embodiment shown in FIG. 5, the mica shield 47 is replaced with a synthetic sapphire shield 47′. In this embodiment, level gauge 40′ comprises glass lense 46′ having features similar to those described above, ie. it is manufactured using tempered aluminosilicate or borosilicate glass, and is approximately 0.5 inches in thickness. The synthetic sapphire shield 47′ ranges from approximately 0.01 to approximately 0.015 inches in thickness, in order to correspond with the thickness of mica shield 47, and is thus compatible with the parts normally used to manufacture fluid level gauge 40.

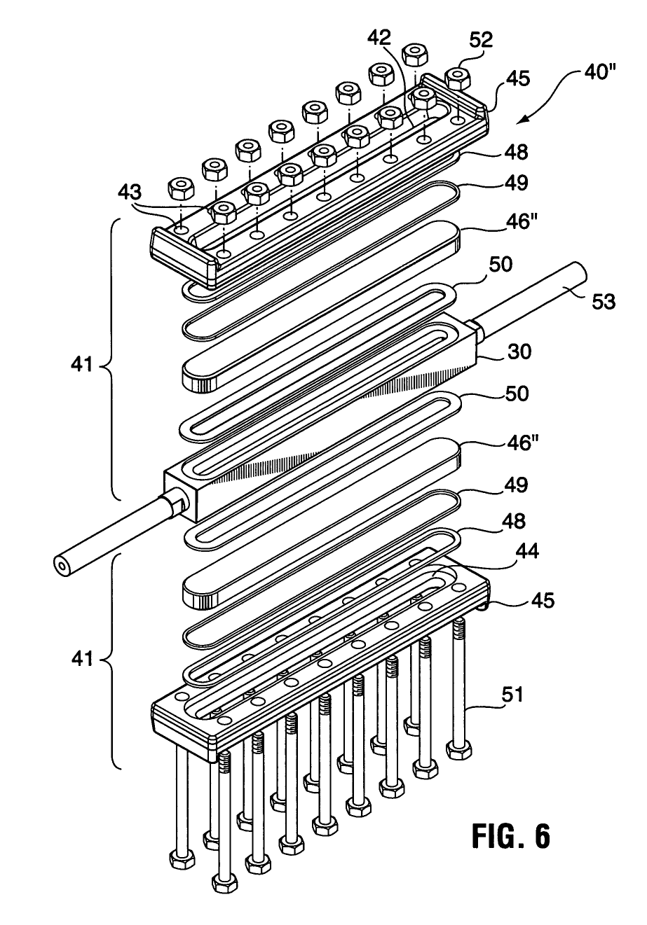

In the embodiment shown in FIG. 6, the combination of mica shield 47 and glass lense 46 is replaced with a single synthetic sapphire lense 46″. Although the thickness of the material may vary, the synthetic sapphire lense 46″ is preferred to have a thickness roughly equivalent to the stack-up height of glass lense 46 and mica shield 47, in order to ensure compatibility with parts and materials commonly used in the manufacture of fluid level gauge 40. Accordingly, synthetic sapphire lense 46″ used in level gauge 40″ will typically be about 0.41 to about 0.615 inches in thickness, and preferably about 0.51 inches in thickness, in order to facilitate the use of commonly available parts in the manufacture thereof. Alternatively, multiple synthetic sapphire lenses 46″ of various thickness can also be combined to attain the total thickness required.

The foregoing are exemplary embodiments of the present invention, and a person skilled in the art would appreciate that modifications to these embodiments may be made without departing from the spirit and scope of the invention defined in the accompanying claims. All documents identified above are herein incorporated by reference.

1. A fluid level gauge for measuring a fluid level in a tank interior, said fluid level gauge comprising:
a gauge body defining a cavity and having first and second end openings respectively formed at or near first and second ends of the gauge body, said end openings allowing fluid communication between the gauge body exterior and the cavity; and
viewing means disposed in a side wall of said gauge body for observation of the cavity interior, and comprising one or more synthetic sapphire shield or synthetic sapphire lense;
wherein the synthetic sapphire shield or synthetic sapphire lense is sealingly engaged in fluid-tight manner with the side wall of the gauge body and prevents the discharge of steam, water, or other fluids from the tank into the environment when the fluid level gauge is connected to the tank.

2. A fluid level gauge according to claim 1, wherein the gauge is a high pressure gauge for measuring fluid levels in a pressure boiler steam drum.

3. A fluid level gauge according to claim 1, wherein the gauge is a ported style fluid level gauge.

4. A fluid level gauge according to claim 3, wherein the viewing means comprises a plurality of viewing ports affixed to opposing sidewalls of the gauge body in columnar orientation, each viewing port comprising one or more synthetic sapphire shield or lense and being in vertical and horizontal alignment with a corresponding viewing port affixed to the opposing sidewall of the gauge body.

5. A fluid level gauge according to claim 4, wherein the viewing ports each comprise a viewing port assembly, said assembly comprising:
a port cover defining a viewing aperture and a lense support rim for retaining the synthetic sapphire shield within the viewing aperture, and having means for attachment of the port cover to the gauge body; and
a glass lense;
the synthetic sapphire shield being of a thickness sufficient to shield the glass lense from the steam, water, or other fluids which enter the measuring gauge cavity when the fluid level measuring gauge is connected to the tank.

6. A fluid level gauge according to claim 5, wherein said glass lense has a thickness ranging from about 0.4 to 0.6 inches, and said synthetic sapphire shield has a thickness ranging from about 0.02 to about 0.03 inches.

7. A fluid level gauge according to claim 5, wherein the viewing port assembly further comprises:
a cushion gasket;
one or more washers positioned between the cushion gasket and the lense support rim, said cushion gasket being positioned between the glass tense and the one or more washers;
a retaining spring for holding the glass lense centered within the viewing aperture;
a sealing gasket; and
a gasket retainer for holding the sealing gasket centered and for holding the synthetic sapphire shield on the glass lense while the port assembly is assembled;
the sealing gasket either projecting through the center of the gasket retainer and sealing the synthetic sapphire shield directly against the gauge body, or the gasket retainer sealing against the gauge body and the sealing gasket sealing the synthetic sapphire shield against the gasket retainer.

8. A fluid level gauge according to claim 4, wherein the viewing ports each comprise a viewing port assembly, said assembly comprising a port cover defining a viewing aperture and a lense support rim for retaining the synthetic sapphire lense within the viewing aperture, and having means for attachment of the port cover to the gauge body.

9. A fluid level gauge according to claim 8, wherein the one or more synthetic sapphire lense has a total thickness ranging from about 0.42 to about 0.63 inches.

10. A fluid level gauge according to claim 8, wherein the viewing port assembly further comprises:
a cushion gasket;
one or more washers positioned between the cushion gasket and the lense support rim, said cushion gasket being positioned between the synthetic sapphire lense and the one or more washers;
a retaining spring for holding the synthetic sapphire lense centered within the viewing aperture;
a sealing gasket; and
a gasket retainer for holding the sealing gasket centered and for holding the synthetic sapphire lense while the port assembly is assembled;
the sealing gasket either projecting through the center of the gasket retainer and sealing the synthetic sapphire lense directly against the gauge body, or the gasket retainer sealing against the gauge body and the sealing gasket sealing the synthetic sapphire lense against the gasket retainer.

11. A fluid level gauge according to claim 5, wherein said gauge body has threads formed therein for attachment of the port cover, and said means for attachment comprises corresponding threads formed on the port cover, or said gauge body has a plurality of threaded bolt holes formed therein, and said means for attachment comprises two or more bolts which pass through bolt holes defined in the port cover and attach the port cover to the gauge body using said threaded bolt holes.

12. A fluid level gauge according to claim 1, wherein said gauge is a flat glass style fluid level gauge.

13. A fluid level gauge according to claim 12, wherein said viewing means comprises one or more elongated viewing windows affixed to sidewalls of the gauge body, each viewing window comprising one or more elongated synthetic sapphire shields or lenses.

14. A fluid level gauge according to claim 12, wherein said viewing means comprises two elongated viewing windows affixed to opposing sidewalls of the gauge body, each viewing window comprising one or more synthetic sapphire shields or lenses and being in vertical and horizontal alignment with the corresponding viewing window affixed to the opposing sidewall of the gauge body.

15. A fluid level gauge according to claim 14, wherein said viewing windows each comprise a viewing window assembly, said assembly comprising:
a window cover defining an elongated viewing aperture and a lense support rim for retaining the sapphire shield within the viewing aperture, and having means for attachment of the window cover to the gauge body; and
a glass lense;
the synthetic sapphire shield being of a thickness sufficient to shield the glass lense from the steam, water, or other fluids which enter the measuring gauge cavity when the fluid level measuring gauge is connected to the tank.

16. A fluid level gauge according to claim 15, wherein said glass lense has a thickness ranging from about 0.4 to about 0.6 inches, and said synthetic sapphire shield has a thickness ranging from about 0.01 to about 0.015 inches.

17. A fluid level gauge according to claim 15, wherein said viewing window assembly further comprises:
a cushion gasket;
a band positioned between the cushion gasket and the glass lense, said cushion gasket being positioned between the band and the lense support rim; and
a sealing gasket forming a water-tight seal between the synthetic sapphire shield and the gauge body.

18. A fluid level gauge according to claim 14, wherein said viewing windows each comprise a viewing window assembly, said assembly comprising a window cover defining an elongated viewing aperture and a lense support rim for retaining the one or more synthetic sapphire lenses within the viewing aperture, and having means for attachment of the window cover to the gauge body, the one or more synthetic sapphire lenses being of a total thickness sufficient to contain steam, water, or other fluids which enter the measuring gauge cavity when the fluid level measuring gauge is connected to the tank.

19. A fluid level gauge according to claim 18, wherein said one or more synthetic sapphire lenses have a total thickness ranging from about 0.41 to about 0.615 inches.

20. A fluid level gauge according to claim 18, wherein said viewing window assembly further comprises:
a cushion gasket;
a band positioned between the cushion gasket and the synthetic sapphire lense, said cushion gasket being positioned between the band and the lense support rim; and
a sealing gasket forming a water-tight seal between the synthetic sapphire lense and the gauge body.

21. A fluid level gauge according to claim 15, wherein said means for attachment comprises a plurality of bolts which pass through bolt holes formed in said window covers and thread onto nuts, or a clamping mechanism which clamps the viewing windows to the gauge body.

22. A method of manufacturing a fluid level gauge for measuring a fluid level in a tank interior, comprising:
obtaining a gauge body, said gauge body defining a cavity and having first and second end openings respectively formed at or near first and second ends of the gauge body, said end openings allowing fluid communication between the gauge body exterior and the cavity; and
affixing one or more viewing ports or elongated windows to opposing sidewalls of the gauge body, the viewing ports or elongated windows permitting observation of the cavity interior and comprising one or more synthetic sapphire shields or synthetic sapphire lenses.

23. A method according to claim 22, wherein said fluid level gauge is a high pressure gauge for measuring fluid levels in a pressure boiler steam drum, and is of a ported style or flat glass style.

24. Use of synthetic sapphire as a shielding layer for a viewing lense in a fluid level gauge, or as a viewing lense in a fluid level gauge.
